(19) United States
(12) Patent Application Publication
(10) Pub. No.: US 2021/0026505 A1
(43) Pub. Date: Jan. 28, 2021

(54) EXECUTING ON-SCREEN DISPLAYS

(71) Applicant: Hewlett-Packard Development Company, L.P., Spring, TX (US)

(72) Inventors: Xiang Ma, Spring, TX (US); Syed S. Azam, Spring, TX (US); Jose Ticy Lo, Spring, TX (US)

(73) Assignee: Hewlett-Packard Development Company, L.P., Spring, TX (US)

(21) Appl. No.: 16/976,578

(22) PCT Filed: Apr. 17, 2018
(86) PCT No.: PCT/US2018/027867

§ 371 Date: Aug. 28, 2020

(51) Int. Cl. G06F 3/0482; G06F 3/0354; G06F 3/0484; G06F 3/041; G06F 3/0487; G01S 13/08

(52) U.S. Cl. CPC G06F 3/0482; G06F 3/03545; G06F 3/04847; G06F 2203/04807; G06F 3/0487; G01S 13/08; G06F 2203/04108; G06F 3/041

(57) ABSTRACT

Example implementations relate to executing an on-screen display (OSD). For example, a non-transitory machine-readable medium storing instructions executable by a processing resource of a parent device to determine a distance between a sensor and a pointing object and execute an OSD command based on the distance between the sensor and the pointing object.

### BACKGROUND

For users to adjust parameters related to video and audio (e.g. brightness, hue, contrast, size, position, vertical/horizontal scan frequency, language selection, and so on), many displays provide on-screen display (OSD) functions. A display with OSD function may have a plurality of user-operable buttons and knobs disposed on the housing.

### BRIEF DESCRIPTION OF THE DRAWINGS

FIG. 1 illustrates an example of a diagram of an example of a non-transitory machine-readable medium and processing resource for executing an OSD consistent with the disclosure.

FIG. 2 illustrates an example of a computing device for executing an OSD consistent with the disclosure.

FIG. 3 illustrates an example of a method for executing an OSD consistent with the disclosure.

FIG. 4 illustrates an example of a computing device for executing an OSD consistent with the disclosure.

### DETAILED DESCRIPTION

As used herein, term “computing device” can, for example, refer to a device including a processor, memory, and input/output interfaces for wired and/or wireless communication. A computing device may include a laptop computer, a desktop computer, a mobile device, and/or other wireless devices, although examples of the disclosure are not limited to such devices. A mobile device may refer to devices that are (or may be) carried and/or worn by a user. For instance, a mobile device can be a phone, such as a smart phone, a tablet, a personal digital assistant (PDA), smart glasses, and/or a wrist-worn device (e.g., a smart watch), among other types of mobile devices.

Computing devices may include a monitor to provide OSD functions. A monitor may include a plurality of user-operable buttons and knobs disposed on the bezel. By operating the buttons and the knobs on the bezel of the monitor, a user may open an OSD menu and adjust the displaying parameters of the display. However, for operating the buttons and knobs, clear graphic symbols corresponding to the functions of the buttons and knobs may be printed on the bezel of the display. The display may be relatively small in size and may lack space on the bezel for printing the clear graphic symbols corresponding to the functions of the buttons and knobs. Buttons and knobs mounted on the bezel of the monitor may also be hard to access.

Additionally, a computing device may include a monitor with a touch screen display which may replace buttons and knobs to execute OSD functions with a plurality of touch sensors to control the OSD functions of the display. However, the cost of touch sensors may be higher than buttons and knobs and may include the cost for controllers for controlling plural touch sensors. Additionally, corresponding clear graphic symbols may be printed on the bezel of the display.

Accordingly, the disclosure is directed to executing an OSD command consistent with the disclosure. Computing devices disclosed herein may provide a way to execute an OSD using a sensor to replace physical or touch buttons. Specifically, a range sensor may be used to determine a distance between the range sensor and a pointing object to execute the OSD to determine which OSD command is selected.

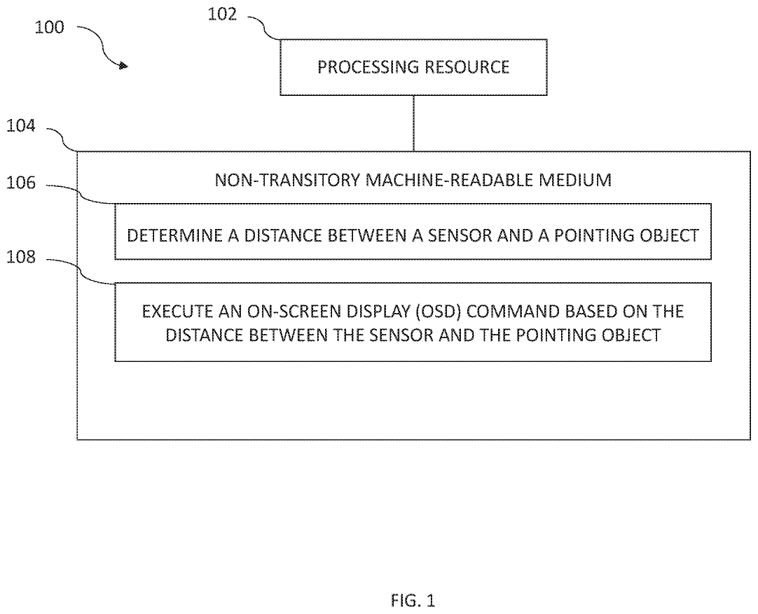

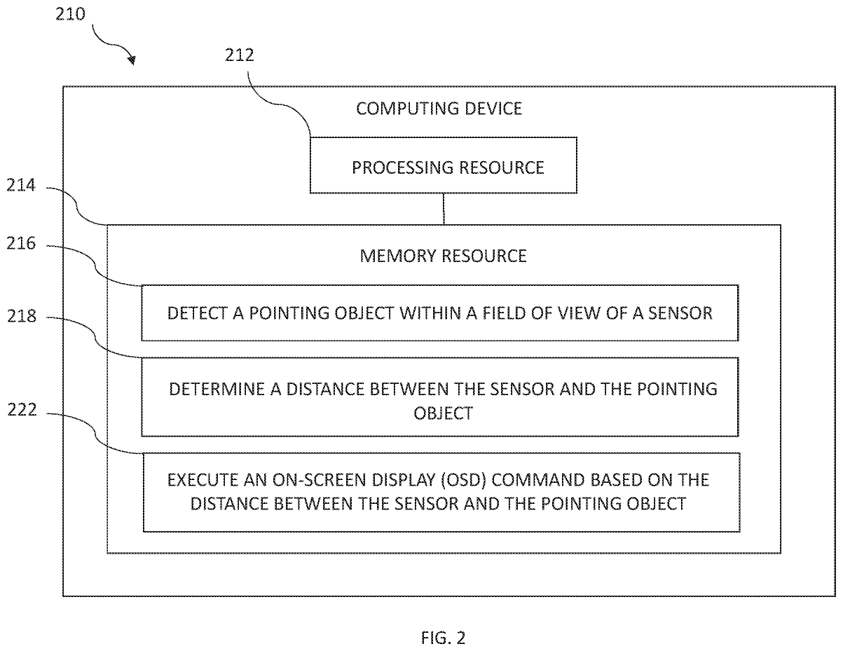

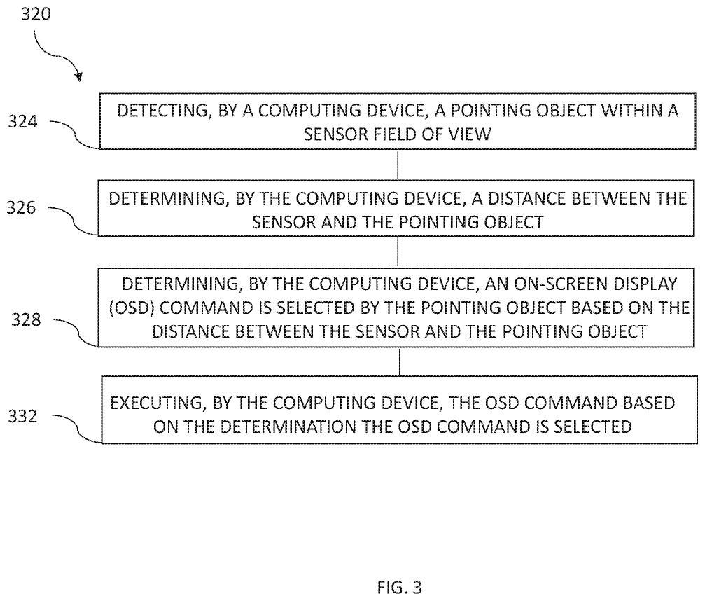

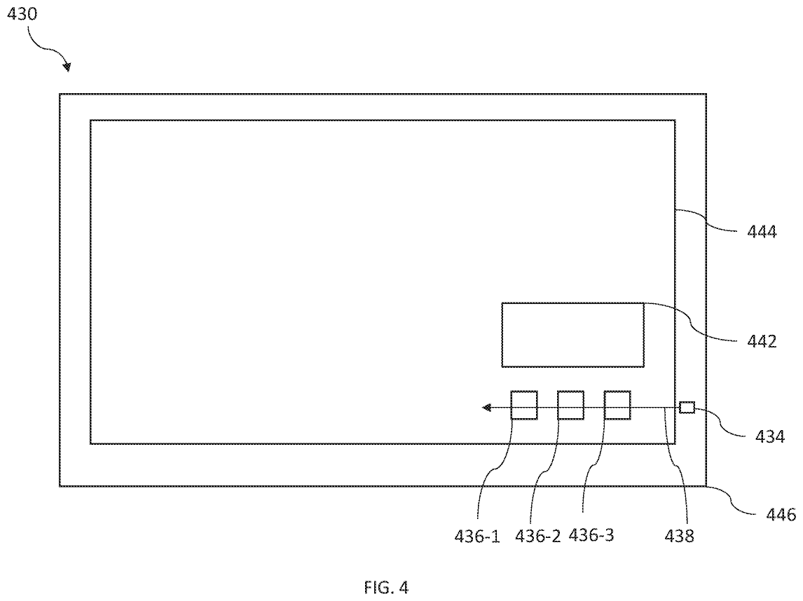

FIG. 1 illustrates a diagram 100 of a processing resource 102 and a non-transitory machine-readable medium 104 for executing an OSD consistent with the disclosure. A memory resource, such as the non-transitory machine-readable medium 104, may be used to store instructions (e.g., 106, 108) executed by the processing resource 102 to perform the operations as described herein. The operations are not limited to a particular example described herein and may include additional operations such as those described in the computing device 100 described in FIG. 2, the method 320 described in FIG. 3, and the computing device 430 described in FIG. 4.

A processing resource 102 may execute instructions stored on the non-transitory machine-readable medium 104. The non-transitory machine-readable medium 104 may be any type of volatile or non-volatile memory or storage, such as random access memory (RAM), flash memory, read-only memory (ROM), storage volumes, a hard disk, or a combination thereof.

The machine-readable medium 104 may store instructions 106 executable by the processing resource 102 to determine a distance between a sensor and a pointing object. The sensor may be a range sensor, such as a time-of-flight sensor. Additionally, the sensor may be used to detect the pointing object near the display of the computing device, as well as sense a location and/or a distance of the pointing object. The pointing object may include a user's finger, a stylus, or any other object that may be used to select an OSD command.

The sensor may be disposed on the bezel of the monitor to detect when the pointing object is near the computing device. For example, the sensor may detect the pointing object within a field of view of the sensor. As used herein, the field of view of the sensor may include a portion of the display that includes an OSD. Detection may include receiving a signal indicative of the presence of an object in the field of view of the sensor. The field of view of the sensor may be an area of interest of the monitor where OSD commands are disposed on the display. In some examples, the bezel of the computing device may include a plurality of sensors to detect the pointing object within each of the plurality of sensors' field of view.

The OSD may include an on-screen menu for making adjustments to the display. In some examples, the OSD may appear on the display of the computing device in response to the user touching the bezel. Once the OSD appears on the display, the user may execute the OSD by touching the display.

The OSD may allow a user to navigate through the on-screen menu and make adjustments using OSD commands, such as a plus (+) and minus (−) command. The OSD may include OSD commands that correspond to a number of computing device functions. For example, the OSD may include OSD commands corresponding to brightness and/or contrast of the display. In some examples, a display may include more advanced OSD commands which allow the user to calibrate individual red, green, and blue (RGB) settings. Additionally, some examples may include OSD commands corresponding to display positioning adjustments, which may be used to make modifications to the position and tilt of the display. A computing device that includes built-in speakers may also include OSD commands corresponding to audio adjustments.

The OSD may be disposed within the field of view of the sensor and superimposed on a picture being displayed on the display of the computing device. In such an instance, the OSD may be content generated by the display independent of content received by the display from the computing device. For example, the OSD may be superimposed on the picture received from the computing device.

The OSD may be a control panel on a computing device display that allows the user to select viewing options and/or adjust components of the display, such as brightness, contrast, and horizontal and vertical positioning. An OSD may include a plurality of OSD commands, where each of the plurality of OSD commands corresponds to a different function of the computing device. For example, a first OSD command of the plurality of OSD commands may correspond to the brightness of the display and a second OSD command of the plurality of OSD commands may correspond to the contrast of the display.

The plurality of OSD commands may be displayed on the display within the field of view of the sensor. The plurality of OSD commands may be displayed as a plurality of graphic symbols within the OSD on the display of the computing device. The graphic symbol may be any graphic symbol that corresponds to the function of the OSD command. In some examples, a first plurality of OSD commands may be displayed on the display within the field of view of a first sensor, while a second plurality of OSD commands may be displayed on the display within the field of view of a second sensor.

The machine-readable medium 104 may store instructions 108 executable by the processing resource 102 to execute an OSD based on the distance between the sensor and the pointing object. The OSD may be displayed on the display within the field of view of the sensor and may include a plurality of OSD commands. Each of the plurality of OSD commands may correspond to a distance from the sensor. For example, a distance of one inch from the sensor may correspond to a first OSD command and a distance of two inches from the sensor may correspond to a second OSD command.

Upon detection of the pointing object within the field of view of the sensor, the sensor may determine the distance between the pointing object and the sensor. For example, the sensor may detect the pointing object is within the field of view of the sensor and determine the distance between the pointing object and the sensor.

The computing device may determine which OSD command from the plurality of OSD commands the user intends to select based on the distance between the sensor and the pointing object. For example, the sensor may determine that the pointing object is one inch from the sensor. The sensor may provide feedback to the computing device, including the distance between the sensor and the pointing object. Based on the distance between the sensor and the pointing object the computing device may determine which of the OSD commands the user intends to select.

For example, the sensor may provide feedback to the computing device including a pointing object is within the field of view of the sensor and a distance of one inch from the sensor. Based on the feedback from the sensor the computing device may determine that the user intends to select the OSD command that corresponds to a distance of one inch from the sensor.

Upon receiving feedback from the sensor, the computing device may execute the OSD command the user intends to select. Executing the OSD command may cause OSD content to be displayed on the display. The OSD content may correspond to the OSD command selected by the user. For example, upon selecting the OSD command corresponding to the brightness of the display, OSD content containing options related to the brightness of the display may appear on the display. OSD content may be superimposed over a picture being displayed on the display of the computing device.

The OSD content may include an indicator relating to the OSD command selected. For example, upon selecting the OSD command corresponding to the brightness of the display, the OSD content that appears on the display may include an indicator that indicates the brightness of the display. In another example, upon selecting an OSD command corresponding to the volume of the computing device, the OSD content may include an indicator on the display that indicates a volume level of the computing device. The indicator may be a graphic that may be displayed within the OSD content that corresponds to the OSD command selected. For example, upon selecting an OSD command corresponding to volume, the OSD content may include a graphic such as a volume control bar.

Once the OSD content is displayed on the display, adjustments may be made using OSD command buttons corresponding to adjusting a computing device feature. For example, OSD command buttons corresponding to adjusting a computing device feature may include a plus (+) OSD command and/or a minus (−) OSD command. In some examples, the brightness of the display may be increased by selecting the OSD command corresponding with the brightness of the display which may result in OSD content corresponding to brightness of the display to appear. To increase the brightness of the display, the plus (+) OSD command may be selected, until the desired brightness is achieved.

In another example, the distance from the sensor may be used to adjust a setting over a range. For example, rather than selecting a (+) or (−) for brightness, the brightness may be a scale from 0 to 100. The distance may be used to determine where on the scale from 0 to 100 the brightness is set. In such an example, a distance of 1 inch may correspond to 0 and a distance of 12 inches may correspond to 100. The user may move the pointing object to a particular value based on feedback from the OSD menu. Additionally, the user may select the particular value by pausing at the distance corresponding to the particular value and move the pointing object perpendicular to the direction used to adjust the setting (e.g., in FIG. 4 away from the screen or up/down), or the like.

The OSD may be displayed on the display of the computing device until the user intentionally exits the OSD or until the OSD has timed out. For example, the user may select an OSD command that corresponds to exiting the OSD or after a predetermined elapsed time the OSD may automatically close. FIG. 2 illustrates an example computing device 210 for executing an OSD consistent with the disclosure. The computing device 210 is not limited to a particular example described herein and may include additional features such as those described in the non-transitory machine-readable storage medium 100 described in FIG. 1, the method 320 described in FIG. 3, and the computing device 430 described in FIG. 4.

The computing device 210 may include a processing resource 212. The computing device 210 may further include a memory resource 214 coupled to the processing resource 212, on which instructions may be stored, such as instructions 216, 218, and 222. In some examples, the instructions may be distributed (e.g., stored) across multiple memory resources and the instructions may be distributed (e.g., executed by) across multiple processing resources.

The processing resource 212 may be a central processing unit (CPU), a semiconductor-based microprocessor, and/or other hardware devices suitable for retrieval and execution of instructions stored in memory resource 214. The processing resource may fetch, decode, and execute instructions 216, 218, and 222 or a combination thereof. As an alternative or in addition to retrieving and executing instructions, the processing resource may include at least one electronic circuit that includes electronic components for performing the functionality of instructions 216, 218, and 222, or a combination thereof.

The memory resource 214 can be volatile or nonvolatile memory. The memory resource 214 can also be removable (e.g., portable) memory, or non-removable (e.g., internal) memory. For example, memory resource 214 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM), flash memory, a laser disc, a digital versatile disk (DVD) or other optical disk storage, and/or a magnetic medium such as magnetic cassettes, tapes, or disks, among other types of memory.

Instructions 214, when executed by the processing resource 212, can cause the computing device 210 to detect a pointing object within a field of view of a sensor. The sensor may be a range sensor, such as a time-of-flight sensor. The sensor, which may be disposed on the bezel of the computing device, may detect the pointing object near the display of the computing device. Additionally, the sensor may sense a location and/or a distance of the pointing object from the sensor. The pointing object may include a user's finger, a stylus, or any other object that may be used to select an OSD command.

The sensor may detect the pointing object is within the field of view of the sensor, The field of view of the sensor may include a portion of the display that includes an OSD, which may include a plurality of OSD commands. The bezel of the computing device may include a plurality of sensors to detect the pointing object within each of the plurality of sensors' field of view.

As described herein, the OSD may allow a user to navigate through the on-screen menu and make adjustments using OSD commands, such as a plus (+) and minus (−) command. The OSD may include OSD commands that correspond to a number of computing device functions. For example, the OSD may include OSD commands corresponding to the brightness of the display, the contrast of the display, the display positioning, and audio adjustments, among other computing device functions.

Instructions 218, when executed by the processing resource 212, can cause device 210 to determine a distance between the sensor and the pointing object. The OSD may be disposed within the field of view of the sensor. Additionally, the OSD may be superimposed on the picture displayed on the display of the computing device. As described herein, the OSD may be a control panel on the computing device display that allows the user to select viewing options and/or adjust components of the display, such as brightness, contrast, and horizontal and vertical positioning. The OSD may include a plurality of OSD commands, where each of the plurality of OSD commands may correspond to a different function of the computing device.

As described herein, the plurality of OSD commands may be displayed as a plurality of graphic symbols within the OSD, which is within the field of view of the sensor. The graphic symbol may be a graphic symbol that corresponds to the function of the OSD command. In some examples, a first plurality of OSD commands may be displayed on the display within the field of view of a first sensor, while a second plurality of OSD commands may be displayed on the display within the field of view of a second sensor.

Instructions 222, when executed by the processing resource 212, can cause device 210 to execute an OSD command based on the distance between the sensor and the pointing object. As described herein, each of the plurality of OSD commands may correspond to a distance from the sensor. For example, a distance of one inch from the sensor may correspond to a first OSD command and a distance of two inches from the sensor may correspond to a second OSD command.

Upon detection of the pointing object within the field of view of the sensor, the sensor may determine the distance between the pointing object and the sensor. For example, the sensor may detect the pointing object is within the field of view of the sensor and determine the distance between the pointing object and the sensor.

The computing device may determine which OSD command from the plurality of OSD commands the user intends to select based on the distance between the sensor and the pointing object. For example, the sensor may provide feedback to the computing device including a pointing object is within the field of view of the sensor and a distance of one inch from the sensor. Based on the feedback from the sensor the computing device may determine that the user intends to select the OSD command that corresponds to a distance of one inch from the sensor.

Upon receiving feedback from the sensor, the computing device may execute the OSD command the user intends to select. Executing the OSD command may cause OSD content corresponding to the selected OSD command to be displayed on the display of the computing device. For example, upon selecting the OSD command corresponding to the brightness of the display, OSD content containing options related to the brightness of the display may appear on the display.

Upon selecting the OSD command corresponding to the brightness of the display, the OSD content that appears on the display may include an indicator that indicates the brightness of the display. In another example, upon selecting an OSD command corresponding to the volume of the computing device, the OSD content may include an indicator on the display that indicates a volume level of the computing device. The indicator may be a graphic that may be displayed within the OSD content that corresponds to the OSD command selected. For example, upon selecting an OSD command corresponding to volume, the OSD content may include a graphic such as a volume control bar.

Adjustments may be made using OSD command buttons corresponding to adjusting a computing device feature. In some examples, the brightness of the display may be increased by selecting the OSD command corresponding with the brightness of the display which may result in OSD content corresponding to brightness of the display to appear. To increase the brightness of the display, the plus (+) OSD command may be selected, until the desired brightness is achieved.

FIG. 3 illustrates a flow diagram of an example of a method 320 for executing an OSD command consistent with the disclosure. The method 320 is not limited to a particular example described herein and may include additional features such as those described in the non-transitory machine-readable storage medium 100 described in FIG. 1, the computing device 210 described in FIG. 2, and the computing device 430 described in FIG. 4.

At 324, the method 320 may include detecting, by a computing device, a pointing object within a field of view of a sensor. As described herein, the sensor may be a range sensor disposed on the bezel of the computing device. Additionally, the sensor may sense a location and/or a distance of the pointing object from the sensor.

The pointing object may include a user's finger, a stylus, or any other object that may be used to select an OSD command. The sensor may detect the pointing object is within the field of view of the sensor. The field of view of the sensor may include a portion of the display that includes an OSD.

At 326, the method 320 may include determining, by a computing device, a distance between the sensor and the pointing object. As described herein, the OSD may include a plurality of OSD commands located within the field of view of the sensor. Upon detecting the pointing object within the field of view of the sensor, the computing device may determine the distance between the pointing object and the sensor.

At 328, the method 320 may include determining, by a computing device, an OSD command is selected by the pointing object based on the measured distance between the sensor and the pointing object. As described herein, the plurality of OSD commands may correspond to different functions of the computing device. Additionally, each of the plurality of OSD commands may correspond to a particular distance from the sensor. For example, a distance of one inch from the sensor may correspond to a first OSD command and a distance of two inches from the sensor may correspond to a second OSD command.

Upon detection of the pointing object within the field of view of the sensor, the sensor may determine the distance between the pointing object and the sensor. The sensor may provide feedback to the computing device including a pointing object is within the field of view of the sensor and the between the pointing object and the sensor. Based on the feedback from the sensor the computing device may determine that the user intends to select the OSD command that corresponds to the determined distance.

At 332, the method 320 may include executing, by a computing device, the OSD command based on the determination of which OSD command the pointing object is selecting. As described herein, upon receiving feedback from the sensor, the computing device may execute the OSD command the user intends to select. Executing the OSD command may cause OSD content corresponding to the selected OSD command to be displayed on the display of the computing device.

FIG. 4 illustrates an example device 430 for executing an OSD command consistent with the disclosure. The device 430 is not limited to a particular example described herein and may include additional features such as those described in the non-transitory machine-readable storage medium 100 described in FIG. 1, the device 210 described in FIG. 2, and the method 320 described in FIG. 3.

As illustrated in FIG. 4 the computing device 430 may include a sensor 434 disposed on the bezel 446 of the computing device 430. The sensor 434 may detect a pointing object is within a field of view 438 of the sensor 434. Additionally, the sensor 434 may determine the distance of the pointing object from the sensor 434. In one example, the sensor 434 may detect the distance parallel to or along the surface of display 444. In another example, the sensor 434 may detect the distance perpendicular to the display 444.

A plurality of OSD commands 436-1, 436-2, and 436-3 may be disposed on the display 444 of the computing device 430. Additionally, the plurality of OSD commands 436-1, 436-2, and 436-3 may be within the field of view 434 of the sensor. Each of the plurality of OSD commands 436-1, 436-2, and 436-3 commands may correspond to particular distance from the sensor 434. For example, OSD command 436-1 may correspond to a first distance, OSD command 436-2 may correspond to a second distance, and OSD command 436-3 may correspond to a third distance. The first distance may be different from the second and third distance, the second distance may be different from the first and third distance, and the third distance may be different than the first and second distance.

In another example, the distance from the sensor 434 may be used to adjust a setting over a range. For example, rather than selecting a (+) or (−) for brightness, the brightness may be a scale from 0 to 100. The distance may be used to determine where on the scale from 0 to 100 the brightness is set. In such an example, a distance of 1 inch may correspond to 0 and a distance of 12 inches may correspond to 100. The user may move the pointing object to a particular value based on feedback from the OSD menu. Additionally, the user may select the particular value by pausing at the distance corresponding to the particular value and move the pointing object perpendicular to the direction used to adjust the setting (e.g., in FIG. 4 away from the screen or up/down), or the like.

Based on the distance between the sensor 434 and the pointing object, the computing device 430 may execute an OSD command that corresponds to the distance between the sensor 434 and the pointing object. Executing the OSD command 436-1, 436-2, and 436-3 may cause OSD content 442 to be displayed on the display 444.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A non-transitory machine-readable medium storing instructions executable by a processing resource to:
determine a distance between a sensor and a pointing object; and
execute an on-screen display (OSD) command based on the distance between the sensor and the pointing object.

2. The medium of claim 1, wherein a plurality of OSD commands are displayed on a display of a computing device.

3. The medium of claim 2, wherein the plurality of OSD commands are disposed within the field of view of the sensor.

4. The medium of claim 2, wherein each of the plurality of OSD commands corresponds to a different function of the computing device.

5. The medium of claim 1, wherein executing the OSD command causes OSD content to be displayed on a display of a computing device.

6. The medium of claim 1, comprising instructions to determine which of a plurality of OSD commands the pointing object is selecting based on the distance between the sensor and the pointing object.

7. A computing device, comprising:
a processing resource; and
a memory resource storing machine-readable instructions to cause the processing resource to:
detect a pointing object within a field of view of a sensor;
determine a distance between the sensor and the pointing object; and
execute an on-screen display (OSD) command based on the distance between the sensor and the pointing object.

8. The computing device of claim 7, wherein the sensor is a range sensor.

9. The computing device of clair herein the pointing object is a user's finger.

10. The computing device of claim 7, wherein the pointing object is a stylus.

11. The computing device of claim 7, comprising instructions to display an OSD on a display of the computing device.

12. A method, comprising:
detecting, by a computing device, a pointing object within a sensor field of view;
determining, by the computing device, a distance between the sensor and the pointing object;
determining, by the computing device, an on-screen display (OSD) command is selected by the pointing object based on the distance between the sensor and the pointing object; and
executing, by the computing device, the OSD command based on the determination the OSD command is selected.

13. The method of claim 12, wherein executing the OSD command includes generating OSD content corresponding to the OSD command on a display of the computing device.

14. The method of claim 12, wherein the OSD command corresponds to a particular distance between the pointing object and the sensor.

15. The method of claim 12, wherein the sensor field of view corresponds to a plurality OSD commands.
